(19) United States
(12) Patent Application Publication
(10) Pub. No.: US 2016/0363756 A1
(43) Pub. Date: Dec. 15, 2016

(54) Novel Optical Instruments with Concave Lenses

(71) Applicant: Ruggero Maria Santilli, Palm Harbor, FL (US)

(72) Inventor: Ruggero Maria Santilli, Palm Harbor, FL (US)

(73) Assignee: Thunder Energies Corporation, Tarpon Springs, FL (US)

(21) Appl. No.: 15/093,705

(22) Filed: Apr. 7, 2016

Related U.S. Application Data
(60) Provisional application No. 62/144,268, filed on Apr. 7, 2015.

(51) Int. Cl. G02B 23/06; G02B 23/12; G02B 7/02; G02B 1/00; G02B 23/16

(52) U.S. Cl. CPC G02B 23/06; G02B 1/007; G02B 23/16; G02B 7/021; G02B 23/12

(57) ABSTRACT

The invention introduces for the first time telescopes for the detection of images originating from light emitted by antimatter stars or galaxies whose specifications are opposite to those of conventional telescopes for the detection of images of far away stars or galaxies in accordance with known conjugations in the transition from matter to antimatter. In particular, conventional convex lenses or concave mirrors for the detection of stars and galaxies are replaced with concave lenses and convex mirrors for the detection of antimatter stars or galaxies. The invention also includes means for the conversion of conventional refractive or reflective telescopes for the detection of matter stars or galaxies into their conjugate for the detection of antimatter stars or galaxies.

### CROSS-REFERENCE TO RELATED APPLICATION

This application is a continuation application of and claims priority from provisional U.S. patent application Ser. No. 62/144,268 filed on Apr. 7, 2015 which is hereby incorporated by reference in its entirety.

### BACKGROUND

### Field of the Invention

The present invention relates to a novel arrangement of optical lenses, and more particularly, an arrangement of optical concave lenses.

There exist today a large variety of telescopes, monoculars, binoculars, camera lens assemblies and other such arrangements of lenses, hereinafter referred to as conventional optical instruments, to focus and amplify light. The light focused by conventional optical instruments is typically the light that is emitted by matter at high temperature, including for example, the light of a star or the light of a flame, hereinafter referred to as matter-light.

Turning to FIG. 1, conventional optical instruments essentially operate in the manner of Galilean's refractive telescopes, or equivalent optical arrangements, whose main principles are as follows. Light 2 is attracted by the gravitational field of a matter body 1 such as Earth, as illustrated in FIG. 1.

FIG. 2 depicts a matter-light beam 4 penetrating within a transparent matter-medium. As a complement of the attraction described above and illustrated in FIG. 1, a matter-light beam 4 penetrating within a transparent matter-medium such as water 3 experiences a deviation from its natural trajectory for an angle 5. The angle 5 will tend to be positive, as light passes from a medium of one density (e.g., air) to a medium of a greater density (e.g., water). The deviation of the light from its natural trajectory is called refraction, as illustrated by angle 5 in FIG. 2.

FIG. 3 depicts a convex lens. Conventional optical instruments use refraction, as described above in conjunction with FIG. 2, to focus the image of a faraway matter object such as a star. This is typically done in a telescope or binocular using one or more convex lenses 6, of the general type depicted in FIG. 3. A convex lens is characterized by curvature that is oriented toward the source, as illustrated in FIG. 3.

FIG. 4 depicts a conventional optical instrument in the form of a Galilean telescope. A Galilean telescope for viewing light 50 from a faraway star is composed of a tube 7 containing in its interior a convex primary lens 6 that focuses the image in the eyepiece or camera 8. The telescope is completed with a mechanism 9 configured for a fine adjustment to alter the distance between lens 6 and the eyepiece or camera 8. The adjustment assures that eyepiece or camera 8 is at the correct focal distance of lens 6, as illustrated in FIGS. 4 and 5. Binoculars or other conventional optical equipment for viewing images of matter-light adhere to the same general principles as the Galilean telescope.

### SUMMARY

Embodiments disclosed herein address the above stated needs by providing systems and methods for making and using optical instruments with concave lenses.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 illustrates matter-light being attracted to a gravitational field.

FIG. 2 depicts a matter-light beam 4 penetrating within a transparent matter-medium.

FIG. 3 depicts a convex lens.

FIGS. 4-5 depict a conventional optical instrument in the form of a Galilean telescope.

FIG. 6 depicts a convex lens assembly according to an embodiment of the present invention.

FIG. 7 illustrates antimatter light being repelled by the gravitational field of a matter-body.

FIG. 8 illustrates the refraction of antimatter light as it passes from a transparent material of a given density to a material of higher density.

FIG. 9 depicts a concave lens for focusing antimatter-light from a faraway antimatter star or galaxy.

FIG. 10 depicts an isodual optical instrument using a concave lens as shown in

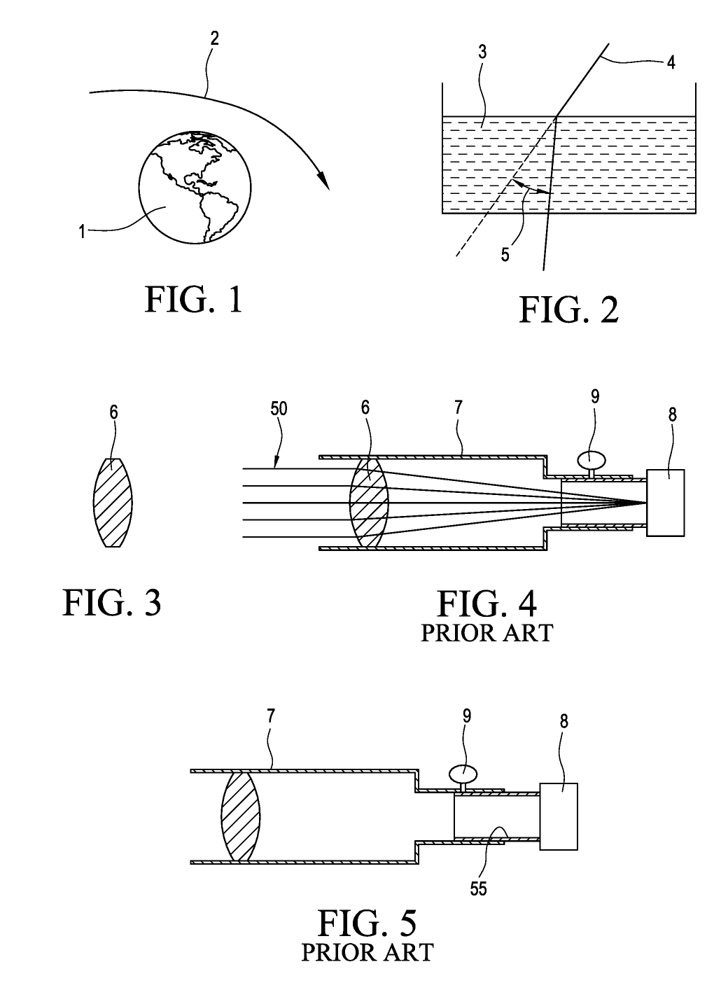

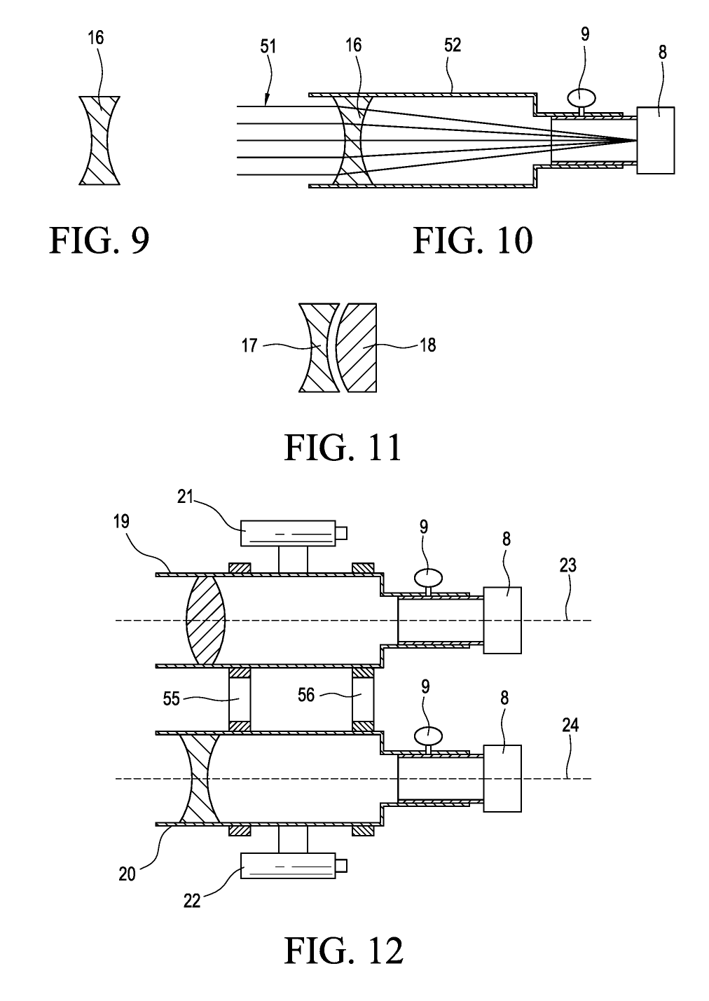

FIG. 9 according to various embodiments disclosed herein.

FIG. 11 depicts a concave lens assembly that includes a concave lens and a conjugate lens for reducing aberration in the viewed object according to various embodiments disclosed herein.

FIG. 12 depicts an isodual telescope according to various embodiments disclosed herein paired with a conventional Galilean telescope for spotting purposes.

FIGS. 13-15 depict experimental results from both an isodual telescope and a conventional Galilean telescope.

FIG. 16 depicts an optical arrangement of two lenses designed to decrease aberration according to various embodiments disclosed herein.

FIGS. 17-18 depict an optical arrangement for converting a Galilean refractive telescope into an isodual telescope according to various embodiments disclosed herein.

FIG. 19 depicts another class of telescope for the focusing of matter-light based on a concave mirror 111, rather than lens 5, according to various embodiments disclosed herein.

FIG. 20 depicts an isodual reflective telescope according to embodiments disclosed herein according to various embodiments disclosed herein.

FIG. 21 depicts an isodual optical assembly resulting from the conversion of a Galilean reflective telescope according to various embodiments disclosed herein.

FIG. 22 depicts a single convex lens with flat back surface illustrating double refraction for proper focusing of matter-light and FIG. 23 depicts the isodual lens of FIG. 22 showing that antimatter-light 301 is subjected to the new isodual refraction.

FIG. 24 depicts an improved single, primary, concave lens with front main concave surface and a back equally concave surface with larger diameter for proper focusing of antimatter-light according to various embodiments disclosed herein.

FIG. 25 depicts an improved doublet to focus antimatter-light consisting of a primary concave lens an inter media convex lens to reduce aberration and a back concave surface with radius larger than the primary one for proper focusing of the antimatter-light according to various embodiments disclosed herein.

FIG. 26 depicts a convex lens suitable for use in various types of telescopes including Galilean refractive telescopes.

FIG. 27 presents TABLE 1 listing manufacturing data for a conventional telescope with 2010 mm primary convex single lens and 1.250 focal distance.

FIG. 28 depicts a single primary lens with double concave surfaces for the proper focusing of antimatter-light.

FIG. 29 presents TABLE 2 listing the manufacturing data for an isodual telescope with single double convex 210 mm lens and 1.250 focal distance.

FIG. 30 depicts a flowchart for a method of practicing an embodiment disclosed herein.

### DETAILED DESCRIPTION

Various embodiments disclosed herein deal with a new type of optical instrument that may take the form of telescopes, monoculars, binoculars or other optical instrument specifically conceived, developed and tested to focus light emitted by antimatter at high temperature. Such light may derive from an antimatter star or antimatter fuel combustion, and is hereinafter called antimatter-light. The new optical equipment is the culmination of research in antimatter by the present inventor—research that began with the discovery of a new mathematics built by the inventor as a member of the Department of Mathematics at Harvard University in the early 1980s. Today this branch of mathematics is known as isodual mathematics. The telescope, binocular or other optical instruments based on the isodual mathematics are, therefore, called isodual telescope, isodual monocular, isodual binocular, or more generally, an isodual optical instrument.

Experimental evidence establishes that in the transition from matter to antimatter there is the conjugation of each and every property belonging to matter. This total conjugation is necessary for the representation of the annihilation of matter and antimatter when they touch each other, to such a level that, in the event only one property of matter is not conjugated in the transition to antimatter, would be inconsistencies for the representation of matter-antimatter annihilation.

The isodual mathematics has been constructed to achieve the conjugation of all physical quantities of matter. The mathematics underlying the conventional Galilean telescope and other optical instruments for matter-light is characterized by the basic left and right units +1 at all levels of study. By contrast, the isodual mathematics underlying the isodual optical instruments is based on the left and right negative unit −1, and then the reconstruction of functional, differential calculus, mechanics, optics, etc., in such a way to admit −1 as the correct left and right unit. On mathematical grounds, the transition from matter to antimatter requires an anti-isomorphism in order to represent experimental evidence, for instance, the annihilation of matter and antimatter at contact. The most elementary mathematics which is anti-isomorpohic to the conventional mathematics used for matter is that whose fundamental left and right unit is −1 at all levels, including numbers, functional analysis, differential calculus, or the like.

The above mathematical and theoretical foundations are described in detail in the monograph by R. M. Santilli entitled “Isodual Theory of Antimatter with Application to Antigravity, Grand Unification and the Spacetime Machine,” Springer (2006), the content of which is hereby incorporated by reference in its entirety for use in explaining the theory and principles of isodual mathematics.

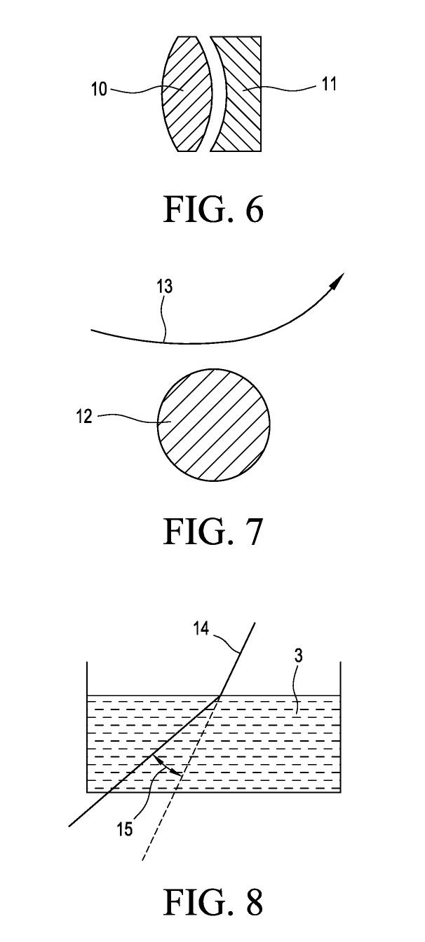

FIG. 6 depicts a convex lens assembly according to an embodiment of the present invention. Since faraway stars have to be studied at the classical level and must be assumed as being neutral, the isodual mathematics has permitted the classical conjugation from a neutral matter-star to a neutral antimatter-star via the conjugation of all physical quantities, except charge. The above main features can be improved in a variety of ways. FIG. 6 illustrates a convex lens assembly for the reduction of the aberration consisting of a convex lens 10 and a conjugate lens 11, with the flat terminal surface arranged as shown in FIG. 6.

Consequently, physical quantities of a matter-star such as mass, energy, speed, or the like are characterized by positive numbers usually measured with positive units of mass, energy, speed, or the like. By contrast, all characteristics of an antimatter-star, such as mass, energy, speed, or the like have negative values as a condition to comply with matter-antimatter annihilation, although said negative values are measured via negative units of mass, negative unit of energy, negative unit of speed, or the like. The referral of negative physical values to negative units of measurement eliminated known inconsistencies for negative physical quantities.

There is a similar conjugation for the transition from matter-light and antimatter-light. Recall that light has no charge. Hence, charge conjugation cannot be used for the conjugation of light. The isocdual mathematics allows indeed a consistent conjugation from matter-light to antimatter-light characterized by the change of sign of all physical quantities, such as energy, frequency, polarization, or the like, although always measured in terms of corresponding negative units. In particular, antimatter-light has negative energy as originally predicted by P. A. M. Dirac in 1932 although measured with a negative unit of energy.

Following decades of mathematical theoretical and experimental research, the present inventor has identified and experimentally confirmed the principles of the isodual telescope indicated below, including for example, the following five principles illustrated in FIGS. 7-11:

1) FIG. 7 illustrates antimatter light being repelled by the gravitational field of a matter-body. For example, antimatter-light 13 is repelled by the gravitational field of a matter-body 12 as illustrated in FIG. 7.

2) FIG. 8 illustrates the refraction of antimatter light as it passes from a transparent material of a given density (e.g., air) to a material of higher density (e.g., water). As a complement of the above repulsion, an antimatter-light beam 14 penetrating within a transparent matter-medium such as water 3 experiences a deviation from its natural trajectory for an angle 15 which is the opposite of the angle 5 of FIG. 2 for matter-light, and is therefore assumed to be being negative. Thus, the antimatter light has a negative index of refraction defined by angle 15, since the antimatter light is deflected in the opposite direction by an amount angle 15 as compared to the deflection angle 5 of FIG. 2 for matter-light. That is, the antimatter light is deflected towards the left side of FIG. 8 (forward, as compared to the angle of entry into the higher density medium) rather than being deflected towards the right side of FIG. 2 for the matter-light (rearward, as compared to the angle of entry into the higher density medium). The deviation of antimatter light passing from a transparent material of a given density (e.g., air) to a material of higher density (e.g., water) is called isodual refraction, as illustrated in FIG. 8.

3) FIG. 9 depicts a concave lens for focusing and amplifying antimatter-light from a faraway antimatter star or galaxy. As a result of a refraction opposite that for matter-light refraction, in order to focus antimatter-light from a faraway antimatter star or galaxy, a telescope must use one or more concave lenses 16 namely lenses whose curvature is oriented away from the source, as illustrated in FIG. 9.

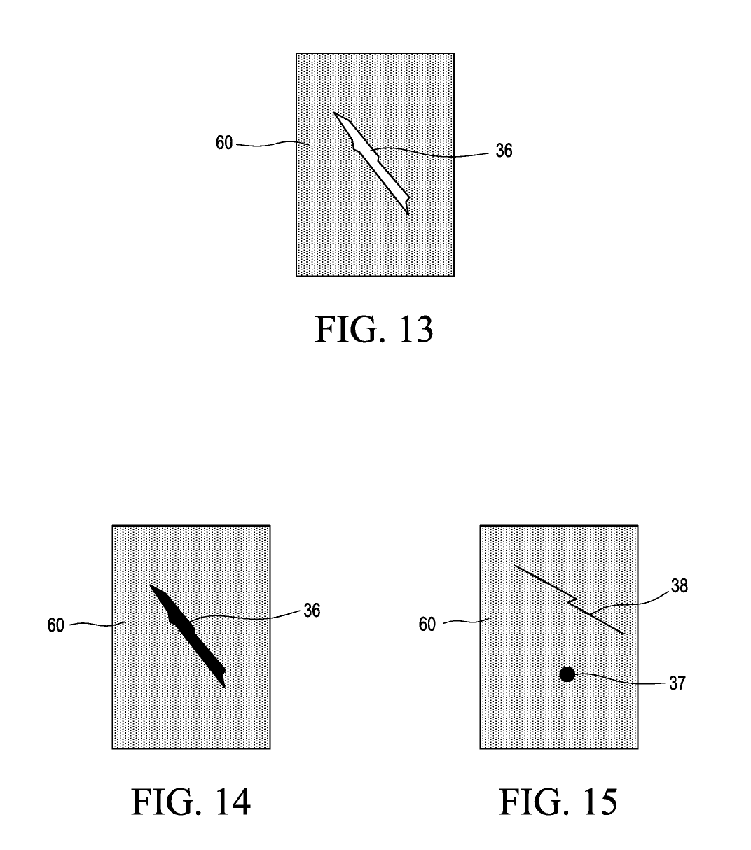

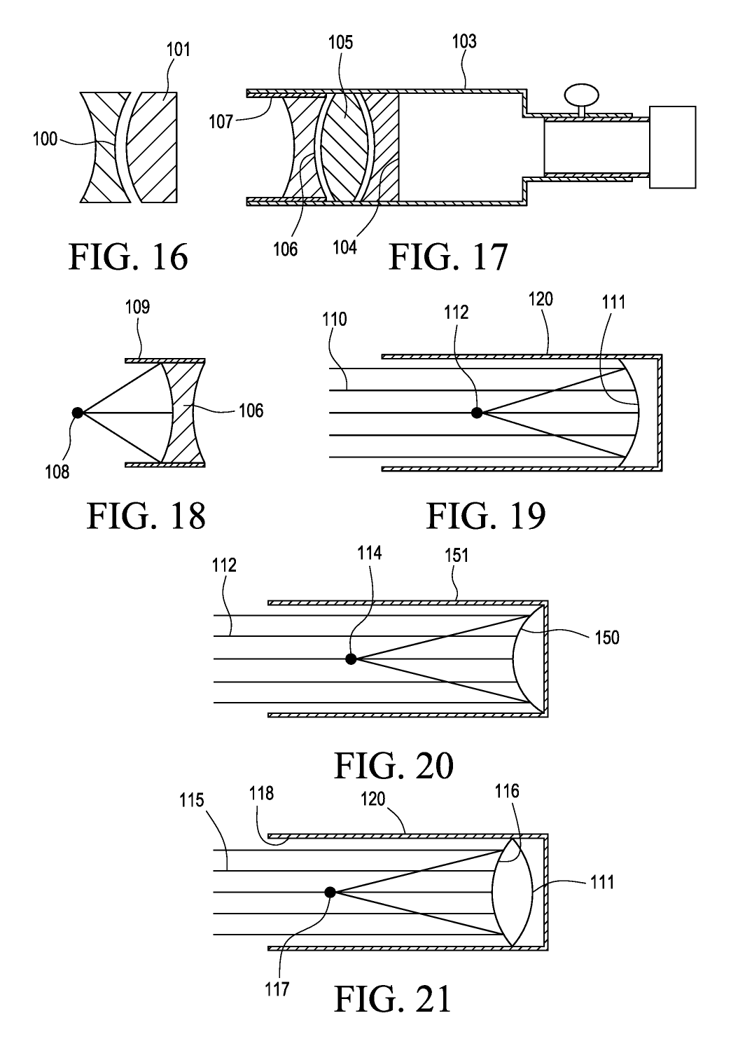

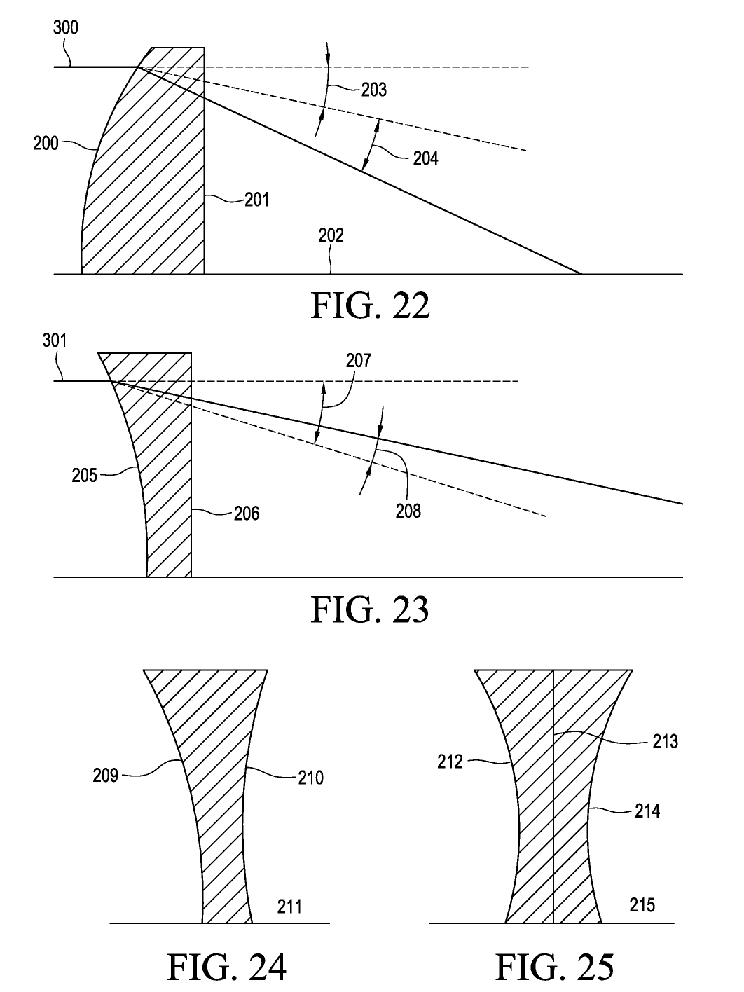

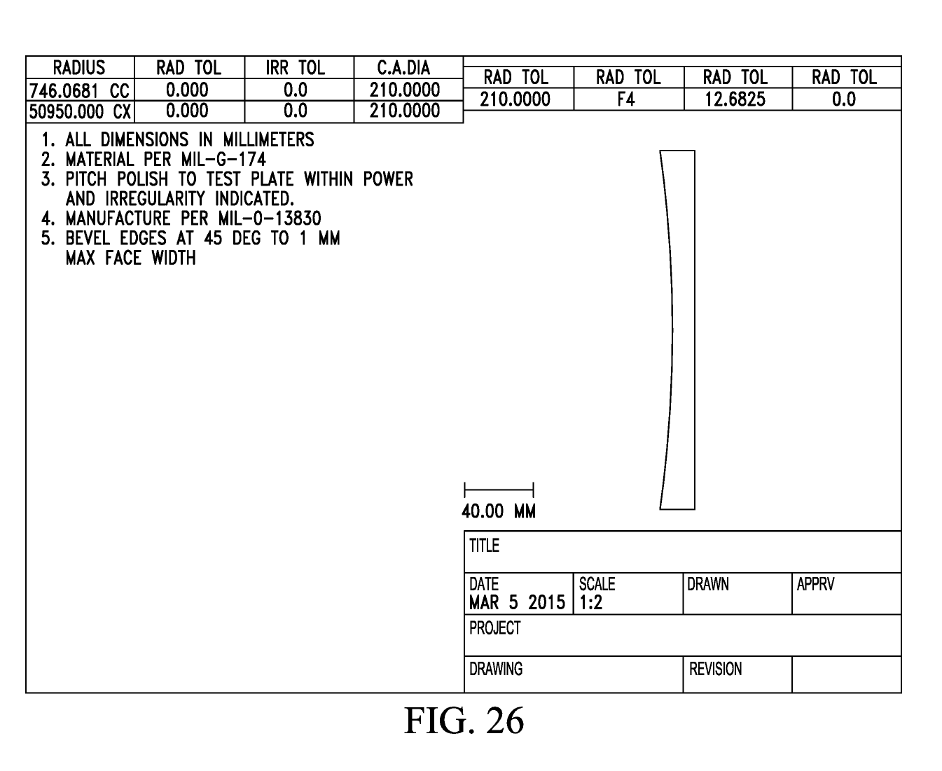

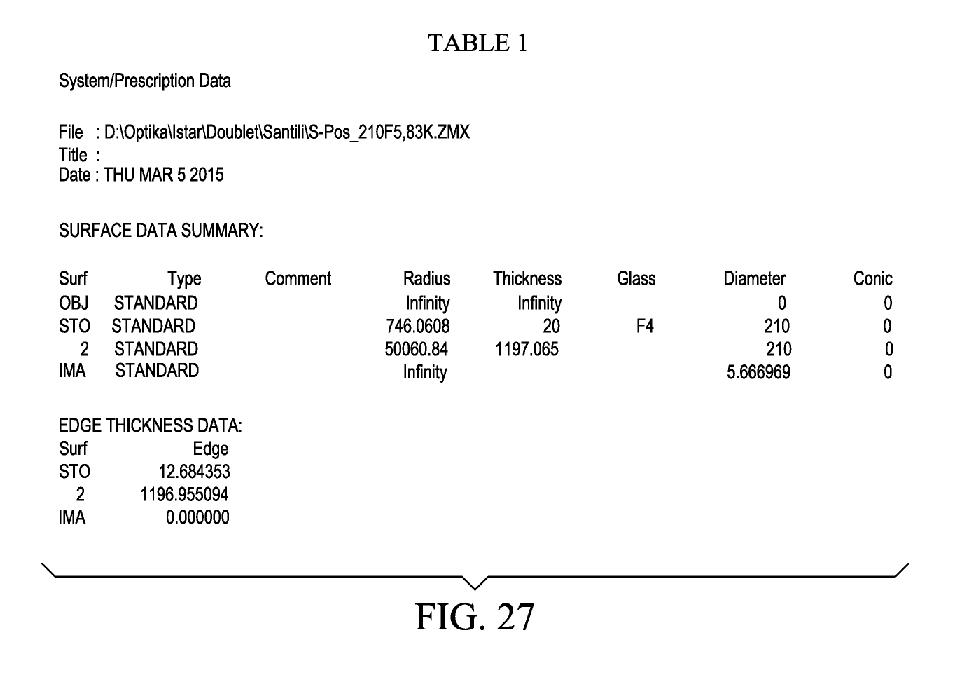

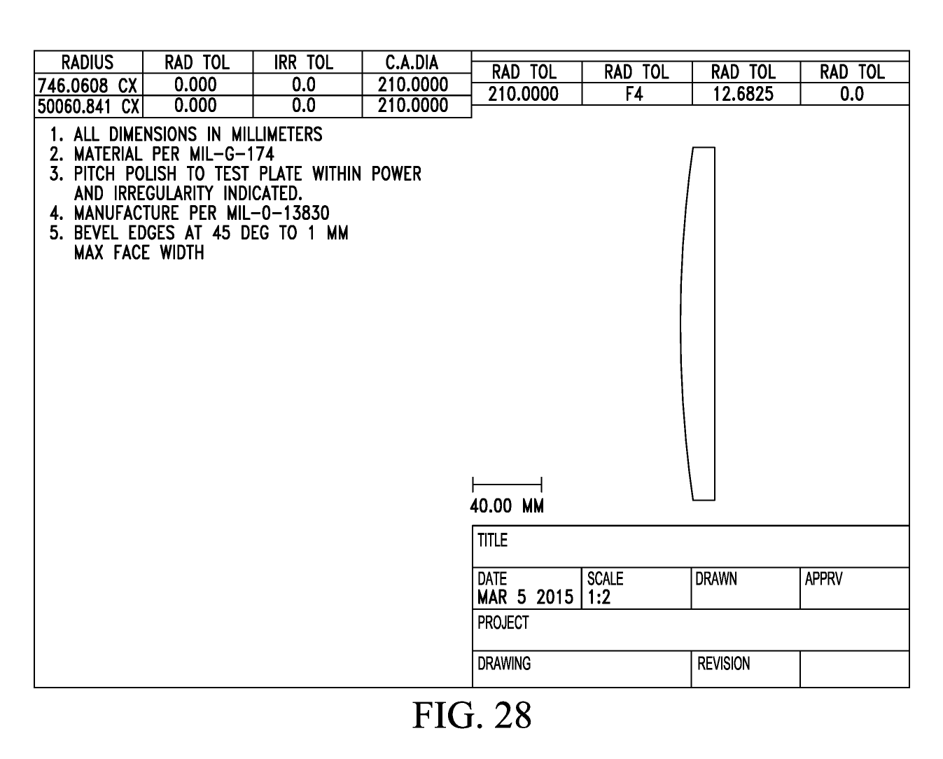

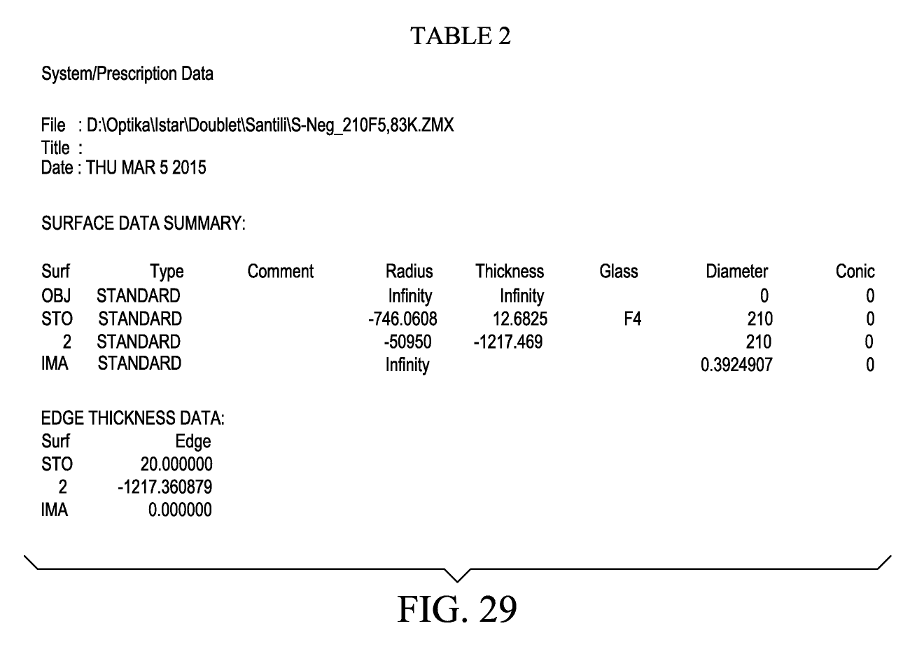

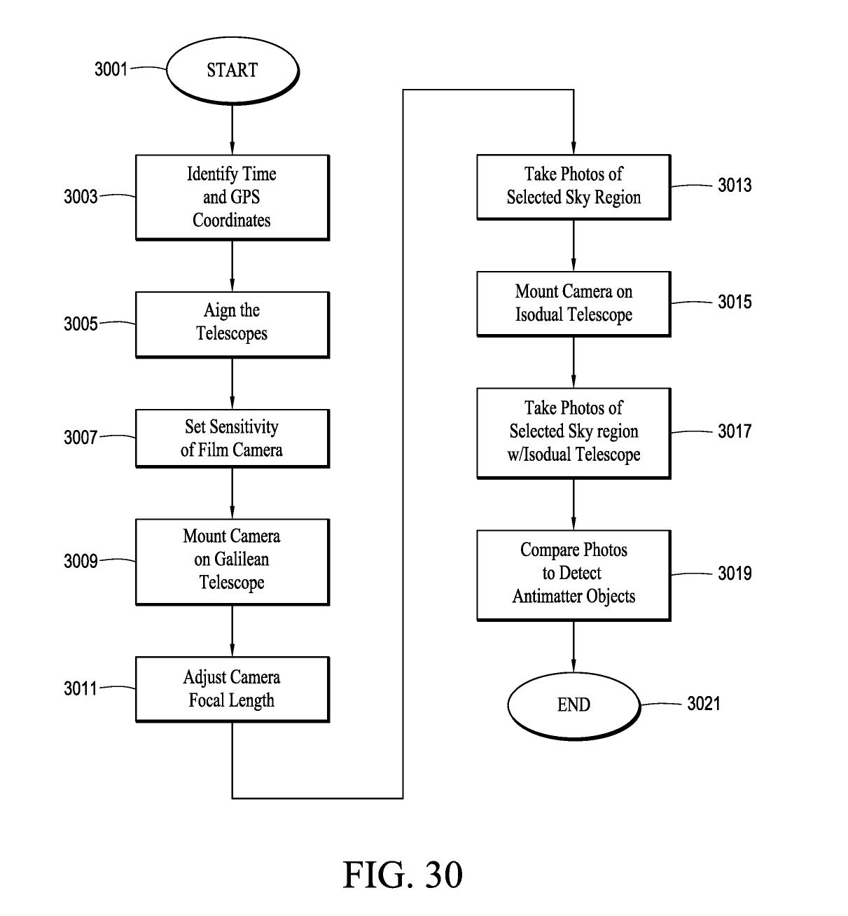

4) FIG. 10 depicts an isodual optical instrument using a concave lens as shown in FIG. 9. The isodual telescope, isodual monocular, isodual binocular or isodual optical instrument for viewing antimatter-light 51 from a faraway antimatter-star or galaxy is typically composed of a tube 52 containing in its interior concave lens 16 that focuses the image of a faraway antimatter star or galaxy in the eyepiece or camera 8. The tube 52 is typically made of a material with sufficient rigidity and strength to hold the lens(es) and eyepiece or camera 8 securely in place. Such materials may include metal, cardboard, plastic or other synthetic solid materials, or the like. The tube 52 often has a round cross-section, but may be configured with a cross-section having various other shapes, e.g., rectangular, triangular, oval, or the like. The tube 52 may be configured with one or more adjustment mechanisms that allows a user to alter the distance between the lens(es) and the eyepiece or camera 8. The device depicted in FIG. 12 is configured with a fine adjustment mechanism 9 to alter the distance from lens 16 to the eyepiece or camera 8. This ensures that the concave lens 16 can be adjusted to be the correct focal distance from the eyepiece or camera 8. The device may also be configured with a course adjustment mechanism for making larger adjustments to the distance from lens 16 to the eyepiece or camera 8. The eyepiece or camera 8 depicted in FIG. 10 is shown mounted at the end of tube 52. In some embodiments, for convenience of the user, the eyepiece or camera 8 is located alongside the tube 52 with an additional assembly of lenses provided to reflect the image from the rear of the tube (where eyepiece or camera 8 is shown in the figure) forward to the more convenient location of the eyepiece or camera 8. In such embodiments the eyepiece or camera 8 may be located anywhere alongside the tube 52, or even away from the tube itself, so long as a lens or mirror assembly is provided to allow antimatter-light 51 traveling down the tube 52 to be directed to, and pass through or into, the eyepiece or camera 8. That is, the eyepiece or camera 8 is configured to receive antimatter-light 51 travelling down the tube 52 and focused by the concave lenses 16 or other lens assembly within the tube.

5) FIG. 11 depicts a concave lens assembly that includes a concave lens 17 and a conjugate lens 18 for reducing aberration in the viewed object. The above main features of the isodual optical instruments can be improved in a variety of ways. For instance, for the reduction of the aberration, the concave lens assembly consists of a concave lens 17 and a conjugate lens 18 with flat terminal surface shown in FIG. 11.

FIG. 12 depicts an isodual telescope paired with a conventional Galilean telescope for spotting purposes. It should be noted that the isodual telescope does not focus images originating from matter-light, since the latter is dispersed in the internal walls of the telescope. In the same way, the Galilean telescope cannot focus or amplify any image whatsoever caused by antimatter light because the latter too would be dispersed in the internal walls of the telescope.

Consequently, in order to identify which portion of the night sky is observed, the isodual telescope may be combined in pair with a Galilean telescope, as illustrated in FIG. 12 with the optically achieved parallel alignment of their respective symmetry axes 23 and 24 as well as viewfinders 21 and 22. This may be implemented by aligning the two telescopes and fastening them together using brackets 55 and 56. In this way, the identification of the observed region of the sky is made via Galilean telescope and finders 21 and 22.

Both the Galilean and isodual telescopes have a diffused background light 60 that can create difficulties in the detection of images via a digital or film camera. In order to distinguish faint images from said background, the coupled Galilean and isodual telescope are set to view a given region of the night sky for a sufficiently long exposure, such as 15 seconds, or any required length of time from 1 second to 180 minutes or more. Using a sufficient time exposure will create images in the form of a streak 35 in the Galilean telescope that, as such, is so clearly distinguished from the background that its existence is beyond scientific doubt.

Contrary to expectations, the inspection of the night sky via the above identified pair of telescopes has established that the isodual telescope does focus and amplify streaks 36 depicted in FIG. 14 which have the same orientation and length as those of the Galilean telescope. While streaks 35 of FIG. 13 in the Galilean telescope are streaks of light, streaks 36 of FIG. 14 in the isodual telescope are of darkness, thus confirming that antimatter-light has negative energy. The only conceivable or otherwise plausible origin of black streaks 36 is that they originate from antimatter stars or galaxies since there is no possibility whatsoever that such streaks could be formed by matter-light in a telescope with concave lens. More specifically, streaks of ordinary light are formed on a conventional digital camera thanks to the photoelectric effect occurring at the level of individual pixels, according to which ordinary light hitting a pixel creates a different of electric potential which is used by the electronic system to form an image. Since observations have been conducted to date at sea level, the camera used for FIG. 14 did detect diffuse light originating from ordinary galaxies which is depicted as a background in the figures. Therefore, the streaks of darkness repeatedly detected by the inventor and depicted in FIG. 14 can only be created by annulling the photoelectric effect at the level of individual pixels caused by ordinary light. In turn, such annulment of the photoelectric effect is a confirmation of the historical hypothesis by Paul M. Dirac, the discoverer of antimatter, according to which antimatter carries a negative energy. In fact, only a light carrying negative energy can annul the difference of potential created by the photoelectric effect of ordinary. In turn, the negative value of the energy of light emitted by antimatter is a confirmation of the isodual mathematics based on the left and right unit −1. Note the absence of contradiction for negative energy since they are measured with negative units, thus being equivalent, but conjugated to ordinary positive energies measured with positive units.

The present inventor has additionally detected clear dots 37 of FIG. 15, as well as darkness in the image focused by the isodual telescope. The dark dots originate from antimatter cosmic rays since the dots were obtained from a 15 second exposure. Only a virtually instantaneous propagation of light under a 15 seconds exposure could have created dark dots 37. In turn, the sole scientific origin is that of antimatter cosmic rays annihilating in the upper regions of our atmosphere with the resulting antimatter-light rapidly reaching the observer at sea level.

The present inventor has also detected long streaks 38 of FIG. 15 of darkness. This too was observed under 15 seconds of exposure. It should be noted, however, that streaks 38 have an orientation and length completely different than those of streaks 35 and 36. Consequently, the objects originating the latter streaks cannot possibly be faraway antimatter stars or galaxies and cannot possibly be antimatter cosmic rays. The sole plausible scientific origin is that of small antimatter asteroids at great speed annihilating in our upper atmosphere.

FIG. 16 depicts an optical arrangement of two lenses designed to decrease aberration. The basic concave lens of various embodiments disclosed herein can be improved in a number of ways. FIG. 16 illustrates an improvement to decrease aberration via the pairing of concave lens 100 and a convex lens 101 with matching conjugate curvature, the latter ending with a plane surface perpendicular to the symmetry axis.

It should be noted that the human eye will never be able to view antimatter object in a distinct way in the manner of viewing matter objects because the human iris is convex and, as such, it will disperse all over the retina antimatter light, rather than converge it into an image. Yet another novelty of this invention is the experimental confirmation that a film camera 8 is distinctly better than currently available digital cameras for the detection of faint images caused by antimatter-light. This is due to the fact that the chemical processes in a film occur at molecular distances, while processes in the pixels of a digital camera occur at distances at least one thousand times larger. The greater sensitivity of the former over the latter is, therefore, evident.

FIG. 17 depicts an optical arrangement for converting a Galilean refractive telescope into an isodual telescope. Recall than mankind has produced a large variety of telescopes, with several of them being in orbit around Earth outside of the atmosphere and the distortion it introduces. Yet none of the variety of conventional telescopes are capable of detecting antimatter stars or galaxies. Another novelty of this invention is the conversion of a Galilean or similar refractive telescope into an isodual telescope. The conversion may be achieved via the addition of a removable concave lens assembly depicted in FIG. 17 consisting of a tube 107 with outside diameter equal to the inside diameter of tube 103 of a conventional Galilean telescope, which tube 107 is open at one end and at the opposite end a concave lens 106 whose curvature radius is the same as that of the convex lens 104. The concave lens assembly 109, as depicted in FIG. 18, is then inserted inside the tube 103 of the Galilean telescope in such as way that the insert of the concave lens 106 achieves the desired concave conversion of the convex lens 104, at which point the Galilean telescope is turned into an isodual telescope.

The embodiments disclosed herein that convert a conventional refractive telescope into a refractive isodual telescope afford the advantage of the knowledge of the exact location of the region of the sky under detection, since such a location can be accurately detected via the conventional Galilean telescope prior to its conversion into an isodual telescope.

FIG. 19 depicts another class of telescope for the focusing of matter-light is based on a concave mirror 111, rather than lens 5. In this case, as depicted in FIG. 19, matter-light 110 from a faraway star of galaxy enter the tube 120 of the telescope, is reflected by the concave mirror 111 resulting in an image on a camera or other instrument located at the focal point 112.

FIG. 20 depicts an isodual reflective telescope according to embodiments disclosed herein. Yet another novelty of this invention is given by the isodual reflective telescope of FIG. 20 in which the main mirror 150 is convex due to the negative character of the index of refraction and refection of antimatter light. Convex mirror 150 is housed at one end of tube 151 the opposing end being open. Antimatter-light from a faraway antimatter star or galaxy reaches mirror 150 and it is focused on a detecting apparatus 114 which is located at the focal point of mirror 150, The reflective isodual telescope is equipped with mechanical means for small adjustments of the position of detecting apparatus 114 so as to ensure proper focus, external conventional viewer and other conventional components, the details of which would be known to those of ordinary skill in the art and are therefore not depicted in the figures.

FIG. 21 depicts an optical arrangement for converting a conventional reflective telescope into a reflective isodual telescope. Yet another novelty of this invention is the conversion of a conventional reflective telescope into a reflective isodual telescope. As depicted in FIG. 21 the conversion is done via an assembly 118 similar to that of FIG. 18 housing a convex mirror 116 with the same but conjugate focal distance of concave mirror 111 and its own detection apparatus 117 located at the focal point of convex mirror 116. Following the removal of detection apparatus 112 from the conventional telescope, assembly 118 is inserted in inside tube 120 of the conventional reflective telescope, at which point the latter becomes a reflective isodual telescope. The conversion herein considered has the advantage that the region of the sky inspected by the isodual telescope is known with precision because detected via the conventional refractive telescope.

FIG. 22 depicts an isodual optical assembly with a single, primary, convex lens with flat back surface. Another novelty of this invention is given by accurate means for focusing antimatter-light. In FIG. 22, we present the main optics of a single, primary, convex lens 200 with flat back surface 201 perpendicular to the symmetry axis 202, by showing that a conventional matter-light 300 is first subjected to a conventional refraction with angle 203 when passing through the convex lens, and then to a second refraction with angle 204 when passing through the flat back surface, both refractions and related angles being crucial for the accurate prediction of the focal distance as well as its accurate construction, as well known to the skilled in the art.

FIG. 23 depicts the isodual lens of FIG. 22 by showing that, in this case, the flat back surface is divergent, rather than convergent. FIG. 23 illustrates the corresponding case for antimatter-light by showing that antimatter-light 301 passing through the primary concave lens 205 is indeed subjected to the new isodual refraction of this invention with negative angle 207 also called isodual angle, but that, contrary to the case for matter-light of FIG. 22, when antimatter-light passes through the flat back surface 206, it experience a deflection with angle 208, rather than the second isodual refraction needed for proper focusing of the antimatter-light.

FIG. 24 depicts an improved single, primary, concave lens with front main concave surface and a back equally concave surface with bigger diameter for proper focusing of antimatter-light. FIG. 24 illustrates one embodiment disclosed herein for the solution of the above problem and the proper focusing of antimatter-light. FIG. 24 shows the case of one single primary concave lens and essentially consists in the replacement of the flat back surface of FIG. 23 with a concave surface whose radius 210 is bigger than the primary concave radius 209 for an amount set by the isodual focal distance, here referred to the focal distance for isodual lenses of the isodual optical instrument.

FIG. 25 depicts an improved doublet 214 configured to focus antimatter-light consisting of a primary concave lens an inter media convex lens to reduce aberration and a back concave surface with radius larger than the primary one for proper focusing of the antimatter-light according to various embodiments disclosed herein. The embodiment depicted in FIG. 25 may be achieved by combining two complementary flat backed isodual lenses 212 and 213 which are similar to the lens shown in FIG. 23. The lenses 212 and 213 are mated at their flat surface 213.

The following paragraphs include specifications of an embodiment for an isodual telescope or monocular for the focusing of antimatter light as depicted in FIG. 10 with manufacturing data as per actual samples constructed and tested by the inventor.

FIG. 27 presents TABLE 1 listing manufacturing data for a conventional telescope with 2010 mm primary convex single lens and 1.250 focal distance. Consider a conventional refractive Galilean telescope with conventional, convex primary single lens of 210 outside diameter (OD) and 1.250 meter in focal length. The body of the telescope, also called tube, is notoriously realized in light weight synthesis substances, such as PVC, or in aluminum depending on needs. Since such a body is widely available commercially all over the world, its detailed construction data are ignored, and will not be needed by one of ordinary skill in the art. Therefore, we shall concentrate here on the manufacturing data of the primary convex 2010 mm lens which is depicted in FIG. 26 and its manufacturing drawing for the indicated OD and focal length are presented in Table 1 which is provided as part of FIG. 27, with all data, including curvatures and focal distances expressed via positive numerical values as well known to the skilled in the art.

We now consider the isodual telescope or monocular of FIG. 6 for the focusing of antimatter-light with one single, primary, concave lens also of 210 mm OD and with the isodual focal lens of −1.250 meters (that's minus 1.250 meters), by noting that in the isodual optics all isodual quantities, including radii and focal distance are expressed in terms of negative numbers. FIG. 28 presents a drawing of the new single, primary lens with double concave surfaces of this invention while all its construction data are presented in Table 2 which is provided as part of FIG. 29. The extension of the manufacturing data to the double isodual lens of FIGS. 6 and 25 would be known to those of ordinary skill in the art and, therefore, it is omitted for brevity and clarity of description.

FIG. 30 depicts a flowchart for a method of practicing an embodiment disclosed herein. The method of FIG. 30 begins at block 3001 and proceeds to block 3003 to identify information from the Global Positioning System (GPS). In block 3003 the operator identifies an accurate consistent with the GPS system, and also identifies the GPS Coordinates of the optically aligned pair of Galilean and isodual telescopes of FIG. 12 mounted in any desired tripod, the details of which would be known to those of ordinary skill in the art and are therefore not depicted in the figures. The pair of telescopes are then aligned in block 3005 via conventional viewers 21 and 22 to a desired star in the night sky. In block 3007 the selected digital or film camera 8 is set at the desired sensitivity and at the desired exposure generally of the order of 15 seconds or more. Proceeding to block 3009, camera 8 is placed in the Galilean telescope and in block 3011 its focal position is adjusted via means 9m. In block 3013 pictures of the selected region of the night sky may be taken. In block 3015 the same camera 8 may be mounted on the isodual telescope, as depicted in FIG. 12, following assurance that its focal position is the same as that of the Galilean telescope. In block 3017 additional pictures are taken of the selected region of the night sky with the isodual telescope. Block 3019 involves comparative analysis, to detect valid images of antimatter object that are solely present in the pictures taken by the isodual telescope, but absent in the corresponding pictures taken with the Galilean telescope. The method of FIG. 30 ends in block 3020.

The same procedure as above also applies for view of the night sky taken via the conversion of a Galilean telescope into an isodual telescope according to FIGS. 17 and 18. In this case, pictures are first taken via the Galilean telescope, then concave lens assembly 209 is inserted in the Galilean telescope which is then converted into the isodual telescope. Additional pictures of the same region of the sky with the same camera and the same exposure may then be taken with the converted isodual telescope, and the related pictures are subjected to the above indicated comparative analysis.

The same or similar procedures also apply for a pair of conventional reflective and isodual telescopes respectively of FIGS. 19 and 20 optically aligned according to the same rules used for the aligned of the refractive telescopes of FIG. 12. Pictures in the two telescopes are then taken via the same rules as above and subjected to comparative analysis the same rules as those for the conversion of the refractive telescope into an isodual version also apply for the conversion of a reflective telescope into an isotopic version as depicted in FIG. 21.

The following passages describe operation of the isodual telescope or monocular in a first embodiment of this invention, that coupled to an equivalent Galilean telescope or monocular according to FIG. 12, both telescopes having the same 210 mm OD primary lens, the same focal length in absolute value, the same tubes, the same conventional exterior alignment scopes, the same adjustment for the fine setting of the focal distance, and the same final detection, whether a conventional digital or film camera as commercially available all over the world and as very well known to any skilled in the art.

Upon identifying the accurate time, the operator identifies the GPS Coordinates of the optically aligned pair of Galilean and isodual telescopes of FIG. 12 mounted in any desired tripod (not shown). The pair of telescopes may be adjusted to align them via conventional viewers 21m 22 to a desired star in the night sky. The selected digital or film camera 8 is set at the desired sensitivity and at the desired exposure generally of the order of 15 seconds or more. The length, in time, of the exposure depends on the desired length of the streaks so as to be clearly distinct over the background.

Longer, in time, exposures will produce longer lines on the film. Camera 8 is then first placed in the Galilean telescope and its focal position is adjusted via means 9m after which pictures of the selected region of the night sky are taken. Then the same camera 8 is mounted in the isodual telescope as depicted in FIG. 12 following assurance that its focal position is the same as that of the Galilean telescope, and additional pictures are taken of the selected region of the night sky with the isodual telescope. Via subsequent comparative analysis, valid images of antimatter object are those solely present in the pictures taken by the isodual telescope and absent in the corresponding pictures taken with the Galilean telescope.

A similar procedure as above applies for view of the night sky taken via the conversion of a Galilean telescope into an isodual telescope according to FIGS. 17 and 18. In this case, pictures may first be taken via the Galilean telescope. Then the concave lens assembly 209 may be inserted in the Galilean telescope to convert it into an isodual telescope. Additional pictures of the same region of the sky with the same camera and the same exposure may be taken with the converted isodual telescope, and the related pictures are subjected to the above indicated comparative analysis.

A similar procedure also applies for a pair of conventional reflective and isodual telescopes respectively of FIGS. 19 and 20 optically aligned according to the same rules used for the aligned of the refractive telescopes of FIG. 12. Pictures in the two telescopes are then taken via the same rules as above and subjected to comparative analysis the same rules as those for the conversion of the refractive telescope into an isodual version also apply for the conversion of a reflective telescope into an isotopic version as depicted in FIG. 21.

The extension of the above specifications from to arbitrary smaller or bigger diameter telescopes, or to a monocular optical device, is within the skill of one of ordinary skill in the art and it is, and therefore is not further described.

1. An optical instrument comprising:
a tube;
at least one adjustment mechanism mounted on the tube;
a lens assembly at a first end of the tube, the lens assembly being configured to focus and amplify light arriving at the first end of the tube, said light having negative index of refraction; and
an eyepiece connected to the tube, the eyepiece being configured to receive the light focused by the lens assembly and travelling within the tube towards a second end of the tube.

2. The optical instrument of claim 1, further comprising:
a camera for capturing an image at a focal point of the lens assembly.

3. The optical instrument of claim 1, wherein the camera is a film camera.

4. The optical instrument of claim 1, wherein the camera is a digital camera.

5. The optical instrument of claim 2, wherein the lens assembly comprises at least one concave lens having a concave surface that focuses said light passing through the concave surface.

6. The optical instrument of claim 2, wherein the lens assembly comprises at least one reflective convex surface that focuses said light reflecting from said convex surface.

7. The optical instrument of claim 1, wherein the lens assembly comprises a primary lens configured with a concave first side receiving said light and a flat second side opposite the first side.

8. The optical instrument of claim 1, wherein the lens assembly comprises a primary lens configured with two concave sides.

9. The optical instrument of claim 1, wherein the lens assembly comprises a doublet primary lens.

10. The optical instrument of claim 1, further comprising:
a conventional refractive telescope fastened to said tube and configured to focus images into a detecting means, said conventional refractive telescope comprising a primary lens that includes at least one convex lens and at least one concave lens.

11. The optical instrument of claim 1, further comprising:
means for the converting a standard refractive telescope for detecting matter stars into a telescope for detecting antimatter stars, said means for converting comprising an assembly inserted into the standard refractive telescope to replace convex lenses with concave lenses.

12. The optical instrument of claim 1, further comprising:
means for the converting a standard reflective telescope for detecting matter stars into a telescope for detecting antimatter stars, said means for converting comprising an assembly inserted into the standard reflective telescope to replace concave reflective surfaces with convex reflective surfaces.

13. A method of focusing and amplifying light having negative index of refraction, comprising:
receiving said light at a lens assembly affixed to a first end of a tube;
manipulating at least one adjustment mechanism configured to adjust the lens assembly to focus and amplify said light arriving at the first end of the tube;
viewing, through an eyepiece connected to the tube, the light focused by the lens assembly and travelling within the tube towards a second end of the tube; and

14. The method of claim 13, further comprising:
capturing an image at a focal point of the lens assembly with a camera affixed to the tube.

15. The method of claim 14, wherein the camera is a film camera.

16. The method of claim 14, wherein the camera is a digital camera.

17. The method of claim 14, wherein the lens assembly comprises at least one concave lens having a concave surface that focuses said light passing through the concave surface.

18. The method of claim 14, wherein the lens assembly comprises at least one reflective convex surface that focuses said light reflecting from said convex surface.

19. The method of claim 13, further comprising:
converting a standard refractive telescope for detecting matter stars into a telescope for detecting antimatter stars inserting an assembly into the standard refractive telescope to replace convex lenses with concave lenses.

20. The method of claim 13, further comprising:
converting a standard reflective telescope for detecting matter stars into a telescope for detecting antimatter stars by inserting an assembly into the standard reflective telescope to replace concave reflective surfaces with convex reflective surfaces.
